(19) United States
(12) Patent Application Publication
(10) Pub. No.: US 2018/0236441 A1
(43) Pub. Date: Aug. 23, 2018

(54) SEMIAUTOMATIC HYDRAULIC WATER SOFTENER

(71) Applicant: COWAY CO., LTD., Chungcheongnam-do (KR)

(72) Inventors: Hyun Kang LEE, Seoul (KR); Sung Hee LEE, Seoul (KR); Won Tae KIM, Seoul (KR)

(21) Appl. No.: 15/752,150

(22) PCT Filed: Jul. 4, 2016
(86) PCT No.: PCT/KR2016/007167

§ 371 Date: Feb. 12, 2018

(30) Foreign Application Priority Data
Aug. 13, 2015 (KR) 10-2015-0114733

(51) Int. Cl. B01J 49/75; B01D 35/157; B01D 35/30; B01D 41/02; C02F 1/42; B01J 49/50

(52) U.S. Cl. CPC B01J 49/75; B01D 35/157; B01J 49/50; B01D 41/02; C02F 1/42; B01D 35/30

(57) ABSTRACT

The present invention provides a semi-automatic pressure type water softener including: an ionic resin tank (100) provided with an ionic resin; a regeneration vessel (200), into which a regenerant is introduced and which generates reclaimed water filled with the ionic resin; a drain valve (293) provided in the regeneration vessel (200) and configured to discharge residual water to the outside; a water inlet part (400) configured to selectively supply raw water to the ionic resin tank (100) and the regeneration vessel (200); and a timer/ceramic disk conversion valve (300) configured to select any one of a water softening mode, a raw water mode, and a regeneration mode to convert a passage between any two of the water inlet part (400), the ionic resin tank (100), and the regeneration tank (200), wherein the water softener is in the regeneration mode, any one of a first mode and a second mode is selected according to a preset method, wherein the first mode is operated for a preset period of time by the timer/ceramic disk conversion valve 300 such that the raw water is supplied to the regeneration vessel (200) to generate reclaimed water, and wherein in the second mode, the drain valve (293) is opened.

### TECHNICAL FIELD

The present invention relates to a semiautomatic hydraulic water softener. More particularly, it relates to a water softener that may use residual water as reclaimed water or drain the residual water according to selection of modes.

### BACKGROUND ART

Tap water (hereinafter, hard water) includes a large amount of chloride ions in a purification process, and when tap water passes an old pipe or the tap water itself is severely contaminated, various heavy metal ions, such as iron, zinc, lead, and mercury, which are harmful to the human body are included in the tap water. The ion components particularly may be coupled to fatty acids of soap to generate metallic foreign substances, and the fatty acids may contact skin, causing allergy or aging of the skin.

To prevent this, a water softener that forces hard water to pass through strong acid positive ions, such as Na⁺ such that Ca2⁺ and Mg2⁺ that are hard components may be exchanged with Na⁺, to generate soft water.

To achieve this, the water softener includes an ionic resin tank in which water containing sodium ions is stored. Meanwhile, because sodium ions in the ionic resin tank is continuously consumed when the ionic resin tank is continuously used, reclaimed water including sodium ions is generated in a regeneration vessel and passes through the ionic resin tank to fill sodium ions in the ionic resin tank at a specific interval.

To achieve this, a regenerant that may be dissolved in the raw water to generate reclaimed water including sodium ions is filled in the regeneration vessel. A material, such as salt, which includes a NaCl component, is mainly used as the regenerant.

The regenerant may be classified into a block type such as bricks, or a powder type such as powder or small balls, according to the form thereof.

However, In the case of a block type regenerant, it was frequently reported that even though a portion of a block of the block type regenerant is left in a regeneration process, it is necessary to exchange the block with a new block as the generation efficiency of the reclaimed water deteriorates if another portion of the block, in particular, a part of the regenerant, to which raw water is introduced for regeneration is dissolved and disappears.

In the case of a powder type regenerant, it is not easy to use only a desired amount of the regenerant and efficiency is low because the concentration of the reclaimed water (hereinafter, “a salt density”) is not constant.

In particular, when residual water in the regeneration vessel that is a reclaimed water tank cannot be drained by any regenerant, it is mixed with reclaimed water that is generated later, or the concentration of the reclaimed water is changed or contamination occurs.

Meanwhile, the methods of dissolving the regenerant also may be classified into a gravity type in which raw water is introduced by the gravity and a pressure type in which the regenerant is dissolved by a pressure according to an introduction pressure of raw water.

However, in the case of the gravity type, that is, in the automatic regeneration type, times for dissolving the regenerant vary according to the number of reclamations, and in the pressure type, it is difficult to use a powder type regenerant.

KR 2015-0062887A

KR 2013-0112346A

KR 2015-0071174A

KR 2015-0121491A

KR 2015-0002175A

### DISCLOSURE

### Technical Problem

The present invention has been made in an effort to solve the above-mentioned problems.

In detail, the present invention suggests a tablet type regenerant to overcome the problems of the block type regenerant and the powder type regenerant.

In particular, the present invention is to solve a contamination problem by properly using residual water while using a tablet regenerant and achieve uniform salt density.

### Technical Solution

In accordance with an aspect of the present invention, there is provided a semi-automatic pressure type water softener including: an ionic resin tank (100) provided with an ionic resin; a regeneration vessel (200), into which a regenerant is introduced and which generates reclaimed water filled with the ionic resin; a drain valve (293) provided in the regeneration vessel (200) and configured to discharge residual water to the outside; a water inlet part (400) configured to selectively supply raw water to the ionic resin tank (100) and the regeneration vessel (200); and a timer/ceramic disk conversion valve (300) configured to select any one of a water softening mode, a raw water mode, and a regeneration mode to convert a passage between any two of the water inlet part (400), the ionic resin tank (100), and the regeneration tank (200), wherein the water softener is in the regeneration mode, any one of a first mode and a second mode is selected according to a preset method, wherein the first mode is operated for a preset period of time by the timer/ceramic disk conversion valve 300 such that the raw water is supplied to the regeneration vessel (200) to generate reclaimed water, and wherein in the second mode, the drain valve (293) is opened.

The regeneration vessel (200) may be in a vacuum state, and the reclaimed water stayed in the regeneration vessel (200) by a pressure of the raw water may flow to the ionic resin tank (100) if the raw water is introduced to the regeneration vessel (200) at a specific pressure.

The preset method for selecting any one of the first mode and the second mode may include: selecting the first mode if the amount of accumulated raw water introduced in the regeneration vessel (200) in the regeneration mode is less than a preset amount and selecting the second mode if the amount of accumulated raw water is the preset amount or more.

The semi-automatic pressure type water softener may further include: an integrator configured to measure the amount of accumulated raw water introduced into the regeneration vessel (200).

In the first mode, the residual water located in the regeneration vessel (200) and the reclaimed water generated in the regeneration vessel (200) may be mixed to be supplied to the ionic resin tank (100).

The regeneration vessel (200) and the water inlet part (400) may be connected to a raw water introduction line (291), and in the first mode, a preset amount of raw water may be supplied to the regeneration vessel (200) at a preset pressure by the raw water introduction line (291).

In the second mode, the drain valve (293) may be opened and a regenerant introduction request signal may be generated.

The semi-automatic pressure type water softener may further include a detachable residual drain vessel connected to the drain valve (293).

The regenerant introduced into the regeneration vessel (200) may be a tablet type regenerant.

### Advantageous Effects

According to the present invention, because the tablet type regenerant is used, a problem of dissolving only a portion of the block type regenerant and a problem of applying a pressure type in the powder type regenerant are solved. Accordingly, the present invention employs a semi-automatic pressure type water softener.

Further, because a specific amount of raw water for generating reclaimed water is introduced at a specific pressure for a specific period of time, reclaimed water that maintains salt density may be generated. It was identified by the experiments of the present inventor(s) that a suitable salt density of about 9 to 11% is continuously maintained.

The raw water is introduced into the vacuumed regeneration vessel at a specific pressure, and the reclaimed water naturally flows to the ionic resin tank due to the force of the pressure. Here, because the check valve is employed, water is introduced from the ionic resin tank to the regeneration vessel so that a problem of diluting the reclaimed water is also solved.

The residual water left in the regeneration vessel is mixed with the newly generated reclaimed water for a specific period of time to be used, but if a specific time elapses, that is, it is identified that a specific amount of raw water is introduced into the regeneration vessel, the raw water may be discharged to the detachable residual water drain vessel so that a problem of contamination is also solved.

Because the regeneration vessel is divided into two parts by the pass member, the regenerant does not meet the raw water, the reclaimed water, and the residual water, a problem of unnecessarily dissolving the regenerant may be prevented.

### DESCRIPTION OF THE INVENTION

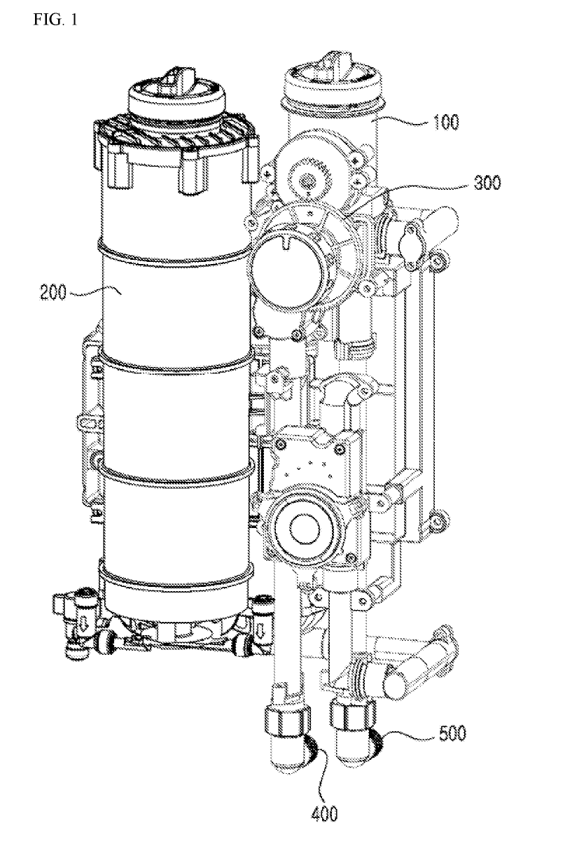

FIG. 1 illustrates a water softener according to the present invention. For description, the cover was omitted;

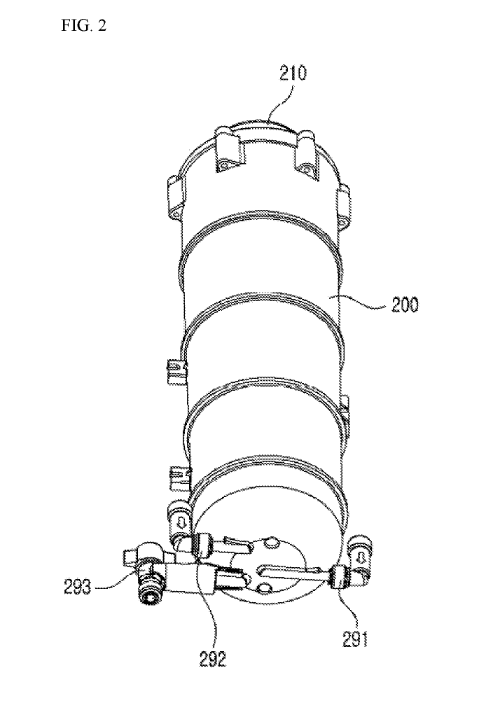

FIG. 2 illustrates a regeneration vessel according to the present invention;

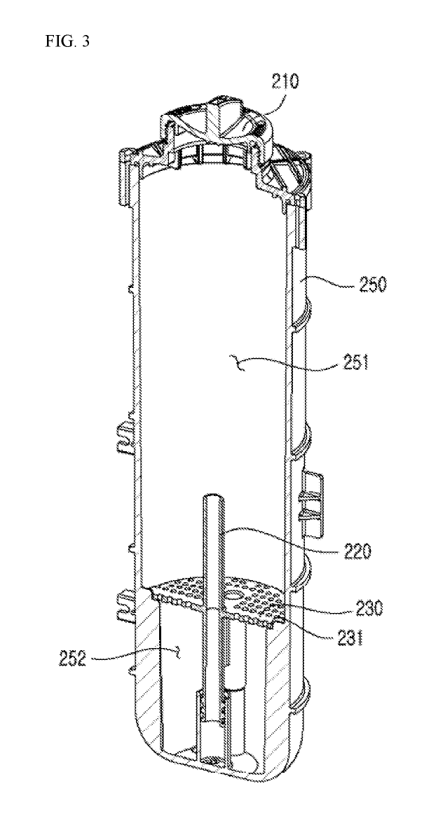

FIG. 3 illustrates a sectional perspective view of the regeneration vessel according to the present invention;

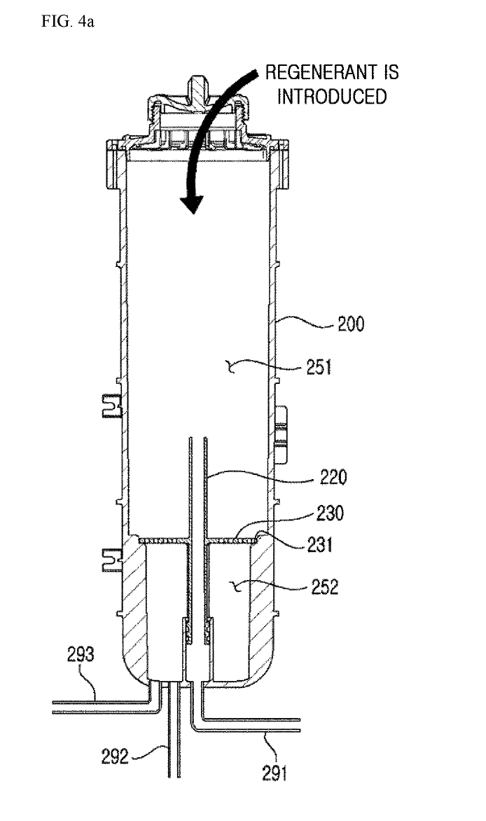

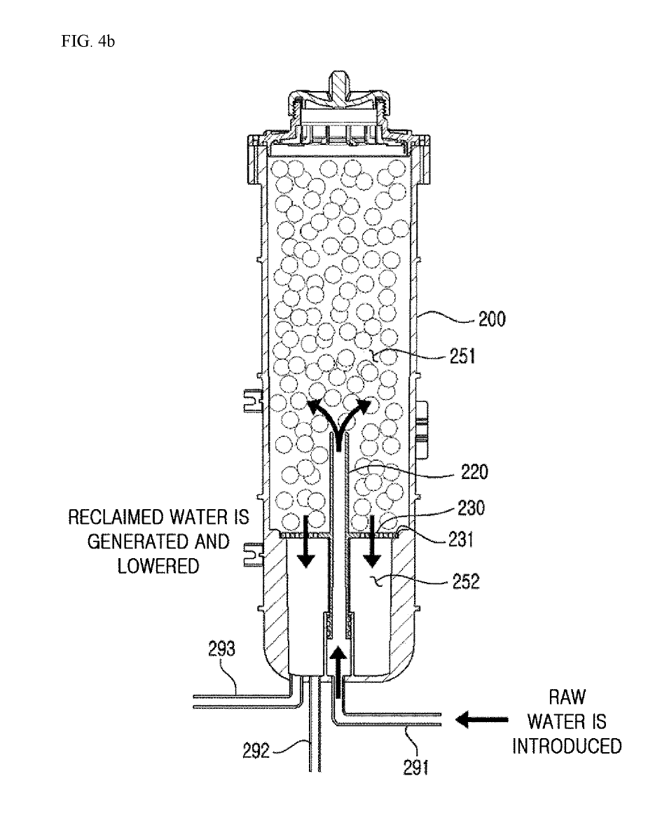

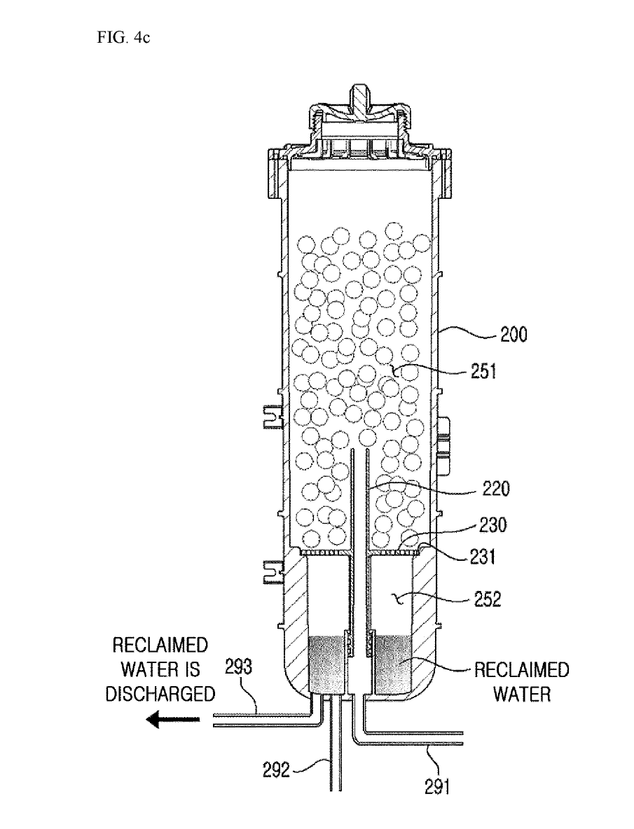

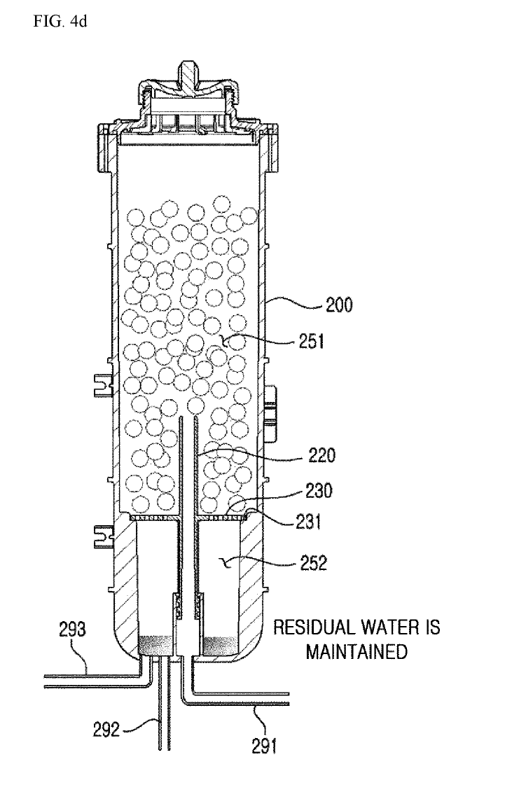

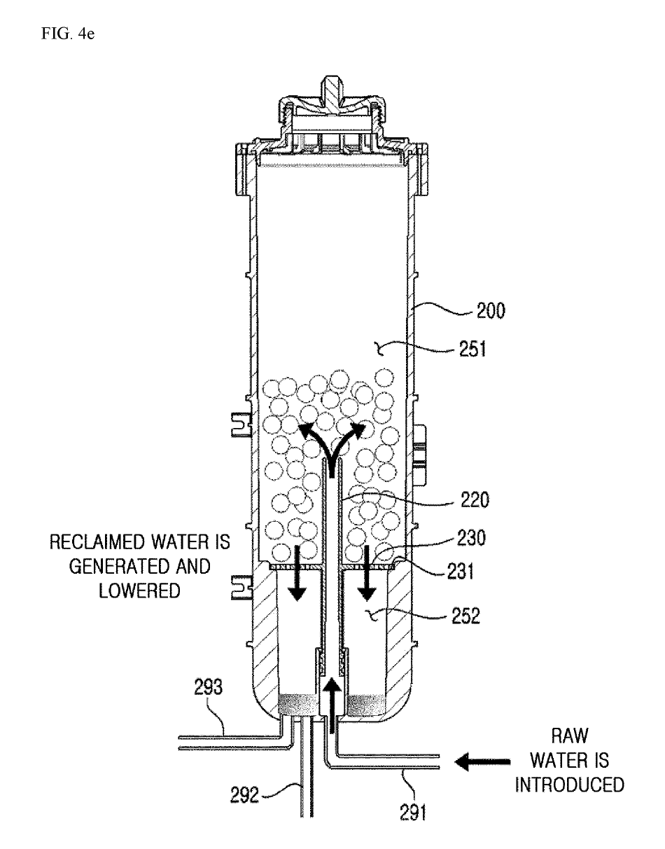

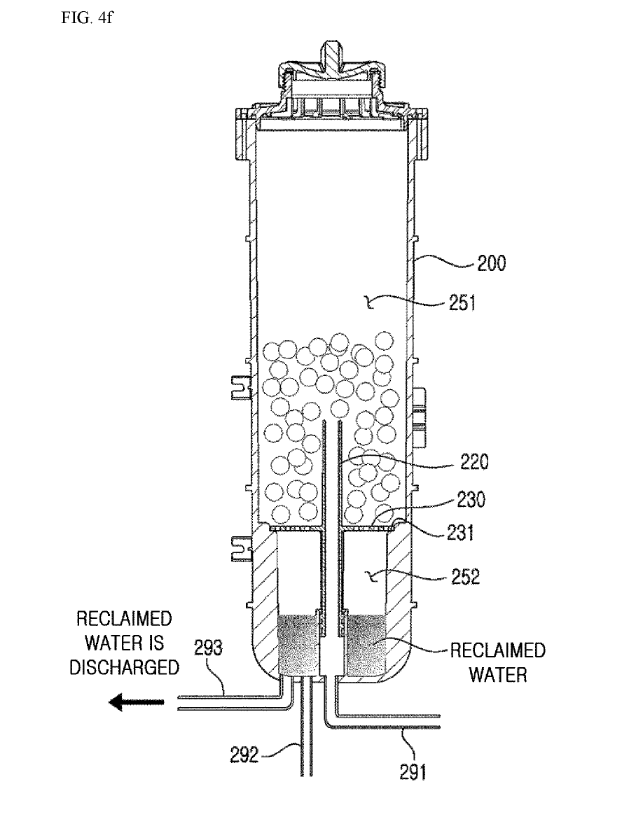

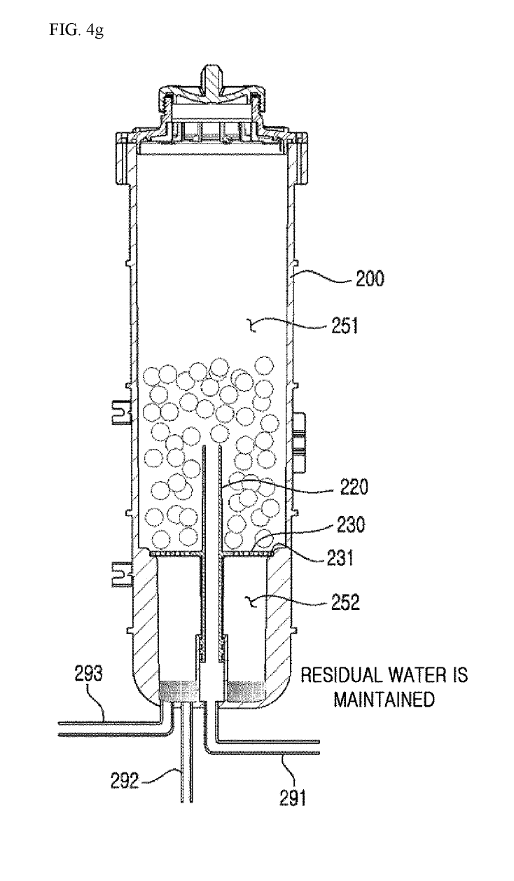

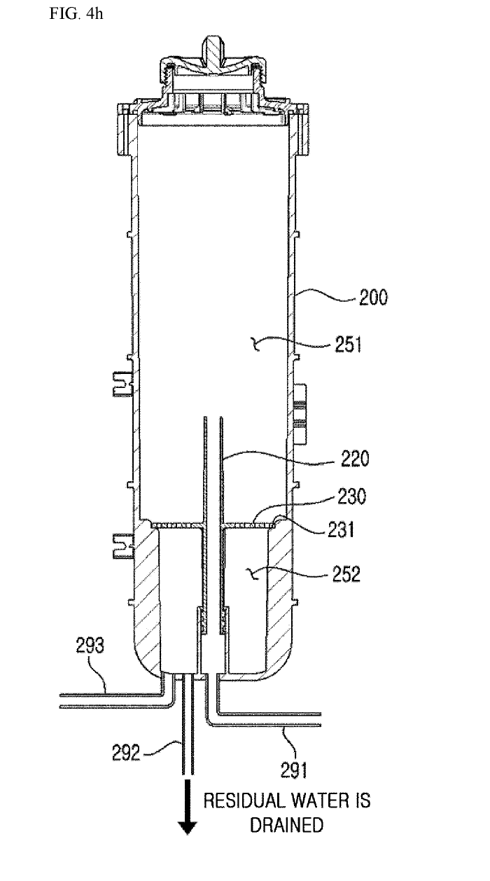

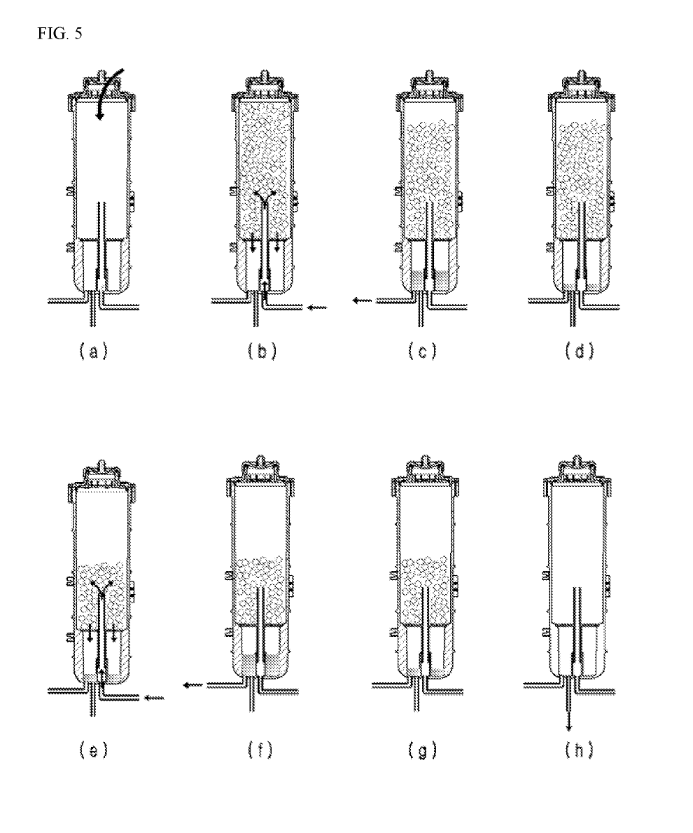

FIGS. 4A to 4H are schematic sectional views for explaining a method for generating reclaimed water of the regeneration vessel according to the present invention, and FIG. 5 illustrates them together; and

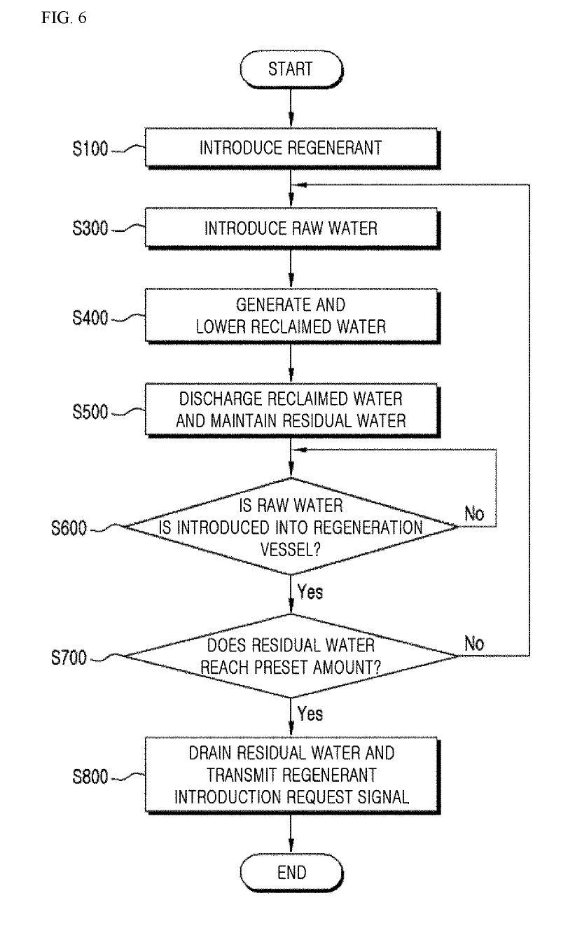

FIG. 6 is a flowchart for explaining the method for generating reclaimed water of the regeneration vessel according to the present invention.

### BEST MODE

Hereinafter, the present invention will be described in detail with reference to the accompanying drawings.

Description of Water Softener

FIG. 1 illustrates a water softener according to the present invention. For description, the cover was omitted.

The water softener according to the present invention includes an ionic resin tank 100, a regeneration vessel 200, a timer/ceramic disk conversion valve 300, a water inlet part 400, and a water outlet part 500.

An ionic resin is provided in the ionic resin tank 100. Here, sodium ions are filled in the ionic resin tank 100.

Since a regenerant may be introduced into the regeneration vessel 200, reclaimed water containing sodium ions is generated and flows to the ionic resin tank 100 when raw water flows to the regeneration vessel 200, and accordingly, sodium ions are filled in the ionic resin provided in the ionic resin tank 100.

A conversion valve of the timer/ceramic disk conversion valve 300 changes a passage as any one of a water softening mode, a raw water mode, and a regeneration mode, and a timer maintains the regeneration mode only for a preset period of time.

The user may select any one of the water softening mode, the raw water mode, and the regeneration mode by manipulating a manipulation part on the outside of the water softener, and the timer/ceramic disk conversion valve 300 is operated to change the passage according to the result.

When the user selects the water softening mode, soft water is discharged through the water outlet part 500. In this case, the raw water introduced into the water softener by the timer/ceramic disk conversion valve 300 through the water inlet part 400 flows to the ionic resin tank 100 such that hard water is softened, and the soft water is discharged to the user through the water outlet part 500.

When the user selects the raw water mode, the raw water is directly discharged from the water outlet part 500. That is, the raw water introduced into the water softener by the timer/ceramic disk conversion valve 300 through the water inlet part 400 is directly discharged to the water outlet part 500 without passing through the ionic resin tank 100.

When the user selects the regeneration mode, the raw water introduced into the water softener by the timer/ceramic disk conversion valve 300 through the water inlet part 400 flows to the regeneration vessel 200 to generate reclaimed water, and the reclaimed water is introduced into the ionic resin tank 100 and is discharged to the outside after the ionic resin is filled with sodium ions.

Here, the regeneration mode is operated only for about 15 minutes by using the timer of the timer/ceramic disk conversion valve 300. Further, a first mode and a second mode are selectively operated. This will be described below in the method for generating reclaimed water.

Meanwhile, the regeneration vessel 200 is located in a residual water drain vessel (not illustrated) that is attachable. Because the drain vessel (not illustrated) communicates with a drain valve 293 of the regeneration vessel 200, the user may completely discharge the residual water in the regeneration vessel 200 to the drain vessel (not illustrated) by opening a drain valve 293 when residual water is left in the regeneration vessel 200 so that it is necessary to discharge the residual water, and the residual water may be discarded separately after being separated from the water softener. Due to the drain valve 293 and the residual water drain vessel (not illustrated), a contamination problem generated by the residual water left in the regeneration vessel 200 may be solved.

Description of Regeneration Vessel

Hereinafter, the regeneration vessel 200 according to the present invention will be described with reference to FIGS. 2 and 3.

When the regeneration vessel 200 is viewed from the outside, a regenerant introduction valve 210 is located at an upper portion of the regeneration vessel 200 and a raw water introduction line 291, a check valve 292, and a drain valve 293 may be located at a lower portion of the regeneration vessel 200.

The regenerant introduction valve 210 is opened to introduce a regenerant into the regeneration vessel 200, and is closed after the introduction is completed. When the regenant introduction valve 210 is closed, an interior space of the regeneration vessel 200 is sealed to continue to be vacuumed.

Here, it is preferable that the regenerant is a tablet type. As mentioned above in the description of the related art, while the block type causes a problem of dissolving only a portion of the regenerant and not being able to dissolve another portion of the regenerant and the powder type cannot employ the pressure type, the tablet type does not cause a problem of dissolving a portion of the regenerant and may employ a pressure type. As will be described below, the generation vessel 200 according to the present invention employs a semi-automatic pressure type.

The raw water introduction line 291 is a line that connects the water inlet part 400 and a raw water introduction member 220 such that a predetermined amount of raw water is supplied to the regeneration vessel 200 to generate reclaimed water.

The check valve 292 is provided in a line that connects the regeneration vessel 200 and the ionic resin tank 100. In detail, the check valve 292 is provided in a line that connects a buffer 252, which will be described below, as a space in which the reclaimed water stays, and the ionic resin tank 100. When the check valve 292 is not provided, soft water may reversely flow from the ionic resin tank 100 to the regeneration vessel 200 so that it is difficult to adjust the salt density of the reclaimed water.

The drain valve 293 allows the residual water left in the regeneration vessel 200 to flow to the residual water drain vessel (not illustrated) when the user opens the drain valve 293.

When the regeneration vessel 200 is viewed from the inside, a plurality of through-holes are located inside the regeneration vessel 200 such that fluid may flow vertically, and a pass member 230 that divides the interior of the regeneration vessel 200 to an upper regenerant storing part 251 and a low buffer 252 is located inside the regeneration vessel 200.

The pass member 230 may be seated on a stepped portion 232 of the regeneration vessel 200.

The sizes of the through-holes of the pass member 230 are smaller than the size of the table type regenerant. Through this, the tablet type regenerant stays only in the regenerant storing part 251 that is an upper space of the pass member 230 and the reclaimed water generated when the regenerant is dissolved in the introduced raw water naturally flows to the buffer 252 after passing through the pass member 230.

As a configuration that passes through the pass member 230, a raw water introduction member 220 that communicates with the raw water introduction line 291 at a lower distal end thereof such that the raw water flows and reaches the regenerant storing part 251 at an upper distal end thereof is located.

The raw water introduction member 220 protrudes further than the pass member 230 by a predetermined length. As described above, the interior space of the regeneration vessel 200 continues to be vacuumed if the regenerant introduction valve 210 is closed, and the raw water introduced through the raw water introduction member 220 has a pressure that presses air and the regenerant in the buffer 252 is automatically discharged to the ionic resin tank 100 by a force of the raw water introduced by the preset pressure.

Further, at the same time, the raw water introduced by the preset pressure through the raw water introduction member 220 is discharged to the regenerant storing part 251 so that the regenerant is smoothly dissolved.

Here, the preset pressure may be 0.7 to 3.0 kgf/cm², and the pressure may be maintained through a fitting part provided in the raw water introduction line 291.

Description of Method for Generating Regenerant

First, the method for generating reclaimed water according to the present invention may be classified into a first mode and a second mode.

The first mode is a mode in which the residual water left in the buffer 252 of the regeneration vessel 200 is utilized as reclaimed water. The residual water left in the buffer 252 of the regeneration vessel 200 needs not to be drained. As described above, as the raw water is introduced into the regeneration vessel 200 at a preset pressure, the residual water (that is, the reclaimed water) left in the buffer 252 starts to flow to the ionic resin tank 100 and the reclaimed water generated from the raw water is mixed with the left water.

The second mode corresponds to a case in which it is determined that it is necessary to discard the residual water. In this case, after the residual water flows to the residual water drain vessel (not illustrated) by opening the drain valve 293, the user may separate the residual water drain vessel (not illustrated) from the water softener and discard the residual water.

It is preferable that the first mode and the second mode are determined by using an amount of accumulated residual water, which is introduced into the regeneration vessel 200.

In an embodiment of the present invention, a one-time regeneration time is about 15 minutes, raw water is introduced at a speed of 140 to 200 ml/min during a one-time regeneration, and the volume of the regeneration vessel 200 is designed such that the regeneration vessel 200 contains the regenerant that may regenerate reclaimed water about 8 times.

Accordingly, by accumulating the amount of the raw water introduced into the regeneration vessel 200, it is identified whether the raw water of 16,800 to 24,000 ml is introduced into the regeneration vessel 200, more preferably, whether the raw water of about 20,000 ml is introduced into the regeneration vessel 200 so that the first mode is operated when the amount of the introduced raw water is less than the reference amount and the second mode is operated when the amount of the introduced raw water is the reference amount or more.

Here, of course, the reference amount exemplarily suggested as 20,000 ml may be arbitrarily modified to the volume of the regeneration vessel 200, a one-time regeneration time, or an introduction speed of raw water.

Although a separate manipulation is not necessary in the first mode, the drain valve 293 is manually or automatically opened and the user is informed that it is necessary to separate the residual water drain vessel (not illustrated), and a regenerant introduction request signal informing that it is necessary to newly introduce the regenerant may be generated at the same time. If the regenerant introduction request signal is generated, a separate alarm light informing the user of the generation of the regenerant introduction request signal is turned on.

(As a result, the regeneration vessel according to the present invention is a semi-automatic pressure type regeneration vessel.)

Hereinafter, the method for generating reclaimed water by using the water softener according to the present invention will be described with reference to FIGS. 4A to 6.

A tablet type regenerant is introduced into a completely empty regeneration vessel 200 (S100, FIG. 4A). Because the regenerant cannot pass through the pass member 230, the regenerant is stored only in the regenerant storing part 251. After the regenerant is introduced, the regenerant storing part 251 continues to be vacuumed.

If the regeneration mode is selected, the water inlet part 400 and the regeneration vessel 200 are communicated with the raw water introduction line 291 by the timer/ceramic disk conversion valve 300 and measurement of time is started at the same time.

The raw water is introduced at a preset pressure from a faucet to the regenerant storing part 251 filled with the regenerant through the water inlet part 400, the raw water introduction line 291, and the raw water introduction member 220. As the raw water introduced by the preset pressure, the regenerant is smoothly dissolved in a wide range (S300).

As soon as the raw water is introduced, the regenerant of the regenerant storing part 251 is dissolved in the raw water to generate the reclaimed water, and the generated reclaimed water passes through the pass member 230 by the self-weight and is collected in the buffer 252 (S400, FIG. 4B).

While the raw water is introduced for about 15 minutes, the reclaimed water is continuously generated and descends and is collected in the buffer 252. The regeneration vessel 200 is still vacuumed. Accordingly, the reclaimed water collected in the buffer 252 by a force of the raw water introduced at a preset pressure flows to the ionic resin tank 100 (S500, FIG. 4C).

After about 15 minutes, the one-time regeneration mode is completed. In detail, the first mode is completed.

After the first mode is completed, the height of the tablet type regenerant in the regenerant storing part 251 is lowered as a portion of the regenerant is dissolved, and the residual water is left in the buffer 252 (FIG. 4D).

If the sodium ions are filled in the ionic resin of the ionic resin tank 100 by performing the one-time regeneration mode, the user may use the soft water for a predetermined period of time again. Thereafter, if it is determined that it is necessary to fill the ionic resin tank 100, the regeneration mode is performed again.

If the regeneration mode is performed, that is, if the introduction of raw water into the regeneration vessel 200 is started (S600), it is determined whether the amount of accumulated raw water introduced into the regeneration vessel 200, which is measured by the integrator, is a preset amount (S700).

If the amount of accumulated raw water introduced into the regeneration vessel 200 less than a preset amount, the first mode is performed again. That is, the raw water is introduced into the regeneration vessel 200 through the raw water introduction line 291 by the timer/ceramic disk conversion valve 300, measurement of time is started, the raw water is introduced at a preset pressure into the regenerant storing part 251 through the raw water introduction member 220, the reclaimed water is generated, and the reclaimed water passes through the pass member 230 and is collected in the buffer 252. In this case, the generated reclaimed water is generated in the former regeneration mode (the first mode) and is mixed with the residual water left in the buffer 252 (FIG. 4E).

The reclaimed water mixed with the residual water flows to the ionic resin tank 100 due to the preset pressure at which the raw water is introduced (FIG. 4F).

If the one time regeneration mode is completed after about 15 minutes, the residual water is left (FIG. 4G).

If the amount of accumulated raw water introduced into the regeneration vessel 200 reaches a preset amount, the second mode is performed. The drain valve 292 is manually or automatically opened such that the residual water is discharged to the residual water drain vessel (not illustrated), the user is informed that it is necessary to separate the residual water drain vessel (not illustrated), and a regenerant introduction request signal informing that it is necessary to newly introduce the regenerant is generated at the same time (S800, FIG. 4H).

That is, if the second mode is completed, neither regenerant nor residual water is in the regeneration vessel 200 as illustrated in FIG. 4A, and the regenerant is introduced into the regeneration vessel 200 again to be used.

Although the present invention has been described with reference to the embodiments illustrated in the drawings such that the present invention may be easily understood by an ordinary person skilled in the art, the embodiments are exemplary, and It will be understood by an ordinary person skilled in the art that various modifications and equivalent other embodiments may be made from the embodiments of the present invention. Therefore, the scope of the present invention should be determined by the claims.

1. A semi-automatic pressure type water softener comprising:
an ionic resin tank provided with an ionic resin;
a regeneration vessel, into which a regenerant is introduced and which generates reclaimed water filled with the ionic resin;
a drain valve provided in the regeneration vessel and configured to discharge residual water to the outside;
a water inlet part configured to selectively supply raw water to the ionic resin tank and the regeneration vessel; and
a timer/ceramic disk conversion valve configured to select any one of a water softening mode, a raw water mode, and a regeneration mode to convert a passage between any two of the water inlet part, the ionic resin tank, and the regeneration tank,
wherein the water softener is in the regeneration mode, any one of a first mode and a second mode is selected according to a preset method,
wherein the first mode is operated for a preset period of time by the timer/ceramic disk conversion valve such that the raw water is supplied to the regeneration vessel to generate reclaimed water, and
wherein in the second mode, the drain valve is opened.

2. The semi-automatic pressure type water softener of claim 1, wherein the regeneration vessel is in a vacuum state, and
wherein the reclaimed water stayed in the regeneration vessel by a pressure of the raw water flows to the ionic resin tank if the raw water is introduced to the regeneration vessel at a specific pressure.

3. The semi-automatic pressure type water softener of claim 1, wherein the preset method for selecting any one of the first mode and the second mode includes:
selecting the first mode if the amount of accumulated raw water introduced in the regeneration vessel in the regeneration mode is less than a preset amount and selecting the second mode if the amount of accumulated raw water is the preset amount or more.

4. The semi-automatic pressure type water softener of claim 3, further comprising:
an integrator configured to measure the amount of accumulated raw water introduced into the regeneration vessel.

5. The semi-automatic pressure type water softener of claim 1, wherein in the first mode, the residual water located in the regeneration vessel and the reclaimed water generated in the regeneration vessel are mixed to be supplied to the ionic resin tank.

6. The semi-automatic pressure type water softener of claim 1, wherein the regeneration vessel and the water inlet part are connected to a raw water introduction line, and
wherein in the first mode, a preset amount of raw water is supplied to the regeneration vessel at a preset pressure by the raw water introduction line.

7. The semi-automatic pressure type water softener of claim 1, wherein, in the second mode, the drain valve is opened and a regenerant introduction request signal is generated.

8. The semi-automatic pressure type water softener of claim 7, further comprising:
a detachable residual drain vessel connected to the drain valve.

9. The semi-automatic pressure type water softener of claim 1, wherein the regenerant introduced into the regeneration vessel is a tablet type regenerant.
